(19) United States
(12) Patent Application Publication
(10) Pub. No.: US 2021/0064397 A1
(43) Pub. Date: Mar. 4, 2021

(54) OPERATION DISPLAY APPARATUS AND OPERATION DISPLAY PROGRAM

(71) Applicant: Southern Wish, Inc., Chuo-ku, Tokyo (JP)

(72) Inventors: Kenro TOKUDOME, Chuo-ku, Tokyo (JP); Shusaku TOHYA, Chuo-ku, Tokyo (JP); Yu YASUTAKE, Chuo-ku, Tokyo (JP)

(73) Assignee: Southern Wish, Inc., Chuo-ku, Tokyo (JP)

(21) Appl. No.: 16/486,894

(22) PCT Filed: Feb. 19, 2018
(86) PCT No.: PCT/JP2018/005818

§ 371 Date: Aug. 19, 2019

(30) Foreign Application Priority Data
Feb. 20, 2017 (JP) 2017-029520

(51) Int. Cl. G06F 9/451; H04L 29/08; G06F 16/14

(52) U.S. Cl. CPC G06F 9/453; G06F 3/0489; G06F 16/148; H04L 67/22

(57) ABSTRACT

An input operation for software including a screen operation performed using a pointing device such as a mouse is visualized. When a pointer operation is performed for software using a pointing device, an operation display apparatus generates an operation image W32 by partially clipping an operation point of a pointer M and a surrounding region from an execution screen W2 of the software. Consequently, the pointer operation for the software can be visualized as the operation image W32.

### TECHNICAL FIELD

The present invention relates to a technique of recording operations for software and a technique of visualizing operations for software.

### BACKGROUND ART

Various applications such as word processing software, spreadsheet software, CAD software, electronic mail software, and programming software are used in businesses and organizations. Such applications are executed on an OS (Operating System) that governs basic control and management of a computer apparatus. Since the OS and the various types of applications executed on the OS (the OS and the applications that are operable by a user will be collectively referred to as “software” in the specification and the claims) typically implement many functions, considerable proficiency based on much knowledge and experience about how to use the software is required to make full use of the software and enhance the work efficiency. Examples of the method of explaining how to use the software include a method in which a screenshot of an execution screen of the software is provided with a description added thereto as in a manual book. Examples of the method also include a method in which a verbal description is provided while an operator is performing a demonstration.

However, the method of explaining how to use the software by providing a screenshot of an execution screen of the software requires enormous time and trouble to prepare a description for each of functions of the software. Thus, the method of explaining how to use the software in a manual book is not very practical. In the method of explaining how to use the software by providing a verbal description and a demonstration, meanwhile, the verbal description often cannot follow key input performed on a keyboard by the operator unless the operator significantly lowers the speed of the key input. In particular, a skilled operator often performs composite key input using modification keys that are not displayed on the execution screen even if such keys are operated. It is significantly difficult for both the operator and a learner that receives the explanation to acquire how to use the software while alternately following the execution screen and the operation on the keyboard with their eyes. With such real-time explanation, moreover, the learner cannot record all the history of key operations by the experienced operator by taking a note. Therefore, it is significantly difficult for the learner to review by himself/herself after the real-time explanation.

As described above, it is not easy for the user to record the history of key operations during use of the software. Therefore, the explanation of how to use the software according to the related art takes time and trouble, and is not efficient. Thus, in practice, the explanation method cannot achieve improvements in work efficiency and productivity that would be expected if an efficient and effective method of using the software had been acquired. For example, programming skills of experienced programmers, which achieve a high work efficiency, are not handed down in many work sites, since such skills are difficult to teach as discussed earlier. In addition, while use of the modification keys in various types of applications such as word processing software, spreadsheet software, and CAD software is also useful in order to enhance the work efficiency and the productivity, the acquisition of use of the modification keys is left to individual efforts.

With such background problems, the present inventors proposed a technique of visualizing a history of key operations performed on a keyboard (PTL 1). Such a technique is very simple and useful in acquiring key operations, since key input data can be acquired from all the key operations for not only display keys, key operations of which are displayed on the execution screen of the software, but also non-display keys, key operations of which are not displayed on the execution screen, to be displayed on the screen.

### CITATION LIST

### Patent Literature

PTL 1: Japanese Patent No. 5828050

### SUMMARY OF INVENTION

### Technical Problem

However, the problems discussed earlier apply to not only key operations performed using the keyboard but also operations performed using a pointing device such as a mouse, a touch pad, and a touch panel. For example, the mouse and the touch pad are operated to move a pointer (also referred to as a cursor) displayed on the execution screen of the software. Meanwhile, the touch panel is operated by the user touching a display screen of a display apparatus with a touch pen or a finger. In order to make full use of the software, operations performed using such a pointing device, e.g. screen operations of clicking a button or a tab displayed on the execution screen, must be performed. With the technique according to the related art described in PTL 1, however, while an operation history of a right click and a left click of the mouse can be recorded, for example, the target of the screen operations, that is, the button or the tab which is clicked, cannot be recorded.

It would be significantly convenient, in acquiring how to use the software, if a history of screen operations performed using a pointing device could be recorded and, further, the recorded operation history could be displayed. In addition, it would be significantly useful if the operation history could be recorded and saved, which would allow management or analysis of the state of use of the software by the user. As far as the present inventors know, however, there is no technique of recording a history of screen operations performed using a pointing device. In addition, there is also no technique of displaying a history of screen operations.

The problem in acquiring how to use the software described above is not limited to domestic and business applications such as word processing software, spreadsheet software, CAD software, electronic mail software, and programming software mentioned above. For example, for a metal working apparatus such as a machining center, a processing condition is specified on an operation screen displayed on a display apparatus. Also for a medical device, an operating condition is specified on an operation screen displayed on a display apparatus. Besides, there are various other apparatuses that involve a screen operation such as industrial devices and medical devices. It would be convenient, in acquiring how to operate such an apparatus, if an operation history for the software used for the apparatus could be recorded and the recorded operation history could be displayed. In addition, it would also be useful, in managing or analyzing the state of use of the apparatus, if the operation history of the apparatus could be recorded and saved.

The present invention has been made in view of the related art described above as the background. It is an object of the present invention to provide a technique of visualizing screen operations for software.

### Solution to Problem

In order to achieve the foregoing object, the present invention is configured to be characterized as follows.

The present invention provides an operation display apparatus that includes an input operation section that is used to operate an execution screen of software, including an image acquisition section that generates, when a screen operation for the software is performed using the input operation section, an operation image acquired by partially clipping an operation point of the screen operation in the execution screen and a surrounding region of the operation point from the execution screen.

With the present invention, the image acquisition section generates the operation image, and therefore it is possible to record, as the operation image, an operation point of an image operation performed for the software using the input operation section and a surrounding region of the operation point. Consequently, it is possible to visualize a screen operation for the software performed by the input operation section. The term “software” as used herein is a term that collectively refers to an OS and various types of applications.

The image acquisition section can generate the operation image such that the operation image includes execution screens of a plurality of pieces of software. A case where an execution screen of one piece of software is displayed on a desktop screen of an OS, for example, is assumed. In the case where the operation point for the software is in the vicinity of an outer frame of the execution screen, a part of the surrounding region of the operation point occasionally includes the desktop screen of the OS. In such a case, the image acquisition section can generate the operation image such that the desktop screen of the OS is partially included in the surrounding region. Similarly, the image acquisition section can generate the operation image so as to extend across execution screens of a plurality of different pieces of software. By capturing a part of a display screen of a display apparatus as it is displayed, the operation point at which the screen operation is performed and the surrounding region of the operation point can be reproduced faithfully.

The operation display apparatus according to the present invention can further include an operation history storage section that records the operation image. With the present invention, the operation image can be saved in the operation history recording section. Thus, with the present invention, the operation image can be checked repeatedly even after the operation image is saved.

The operation history storage section can be a storage apparatus of a computer apparatus that serves as the operation display apparatus which executes the software. Alternatively, the operation history storage section can be a storage apparatus of one or more different computer apparatuses connected via a communication network with a computer apparatus that serves as the operation display apparatus which executed the software. This allows the operation image and the key input data to be saved in the operation history storage section at a remote location, for example, and further allows the image operation and the key operation to be easily grasped visually even at a remote location.

The operation history storage section according to the present invention can record information of time at which the operation image is generated, added to the operation image. With the present invention, the operation image is associated with the time information, and thus not only the content of the image operation but also the time can be recorded. The “time information” includes year, month, day, hour, minute, and second.

The operation history storage section according to the present invention can record identification information of the software, which generates the operation image, added to the operation image. With the present invention, the operation image is associated with the identification information of the software (e.g. the name or an abbreviated name of the software), and thus what image operation is performed for what software can be recorded. In this case, the software for which an operation is performed, the content of the operation, and the time of the operation can all be recorded by recording the operation image with the time information further added thereto.

The operation display apparatus according to the present invention can further include an operation history display section that displays an operation history display screen that includes the operation image. With the present invention, the operation content of the image operation can be accurately grasped visually by displaying the operation image on the operation history display screen.

The operation history display section according to the present invention can display, on the operation history display screen, a plurality of operation images arranged in an order in which the operation images have been generated. With the present invention, the content of the image operations can be grasped chronologically.

The input operation section according to the present invention can be a pointing device. More specifically, the input operation section can be at least one of a mouse, a touch pad, and a touch panel. With the present invention, operations other than keyboard input, including the operation content of the screen operation, can be accurately grasped visually. In the case where the input operation section is a mouse and a touch pad, a screen operation (pointer operation) performed by operating a pointer displayed on the execution screen of the software can be recorded. In the case where the input operation section is a touch panel, a screen operation (touch operation) performed by touching a display screen of a display apparatus with a touch pen or a finger of the user can be recorded.

The operation display apparatus according to the present invention can further include a key input data acquisition section that acquires, as key input data, an operation key, a key operation of which is performed for the software using the input operation section. With the present invention, not only the operation image but also the operation key can be acquired, and therefore both the key operation and the screen operation can be recorded. Specifically, operations for the software performed using both the keyboard and the pointing device can be recorded and displayed.

The operation history storage section according to the present invention can record the operation key in addition to the operation image. With the present invention, the operation image and the operation key can be saved in the operation history recording section. Thus, with the present invention, the operation key can be checked repeatedly even after the operation key is saved. In addition, the operation history storage section can record time information, at which the key operation is performed, added to the operation key. With the present invention, the operation key is associated with the time information, and thus not only the operation content of the key operation but also the operation time can be recorded. The operation history storage section can record the time information added to each operation key. This makes it possible to accurately grasp the operation time for each of individual key operations more particularly.

The operation history display section according to the present invention can display the operation history display screen which also includes the operation key. With the present invention, the operation content of the key operation and the image operation can all be accurately grasped visually by displaying the operation image and the operation key on the operation history display screen.

The operation history display section according to the present invention can display, on the operation history display screen, the operation image and the operation key arranged in an order in which the operation image and the operation key have been generated. With the present invention, the content of the key operation and the image operation can all be grasped chronologically. That is, all the operation history for the software can be saved and visualized.

The operation key according to the present invention can include a display key, the key operation of which is displayed on the execution screen of the software, and a non-display key, the key operation of which is not displayed on the execution screen of the software. With the present invention, key operations of the non-display key such as modification keys, function keys, and lock keys, for example, can also be recorded and visualized.

The operation display apparatus according to the present invention can further include a movie acquisition section that acquires a movie showing the operation for the software. With the present invention, the operation history can be recorded in a movie, and thus the flow of operations can be grasped more specifically.

The operation display apparatus according to the present invention can further include a search section that searches the operation history storage section using a predetermined search condition. With the present invention, an operation history can be found easily using the predetermined search condition from the past operation history data accumulated in the operation history storage section. In this case, examples of the search condition include the name of the software, a desired character string, an operation image, and time information.

In order to achieve the above object, the present invention also provides an operation display program that causes a computer apparatus to function as an operation display apparatus that includes an input operation section that can be used to operate an execution screen of software, in which the computer apparatus is caused to function as an image acquisition section that generates, when a screen operation for the software is performed using the input operation section, an operation image acquired by partially clipping an operation point of the screen operation and a surrounding region of the operation point from the execution screen. The present invention further provides an operation display method including: a step of an input operation section of a computer apparatus performing a screen operation on an execution screen of software; a step of a control section of the computer apparatus detecting the screen operation; and a step of the control section generating an operation image acquired by partially clipping an operation point (center coordinate) of the screen operation and a surrounding region of the operation point from the execution screen. With such aspects of the present invention, as with the operation display apparatus described above, a screen operation for software can be visualized in an operation image each time an image operation is performed.

The operation display apparatus according to the present invention can further include an image acquisition control section that sets the size of the operation image to be clipped from the execution screen. With the present invention, the operation image can be clipped appropriately in accordance with the configuration etc. of the execution screen of the software.

The image acquisition section according to the present invention can acquire an enlarged screen of the execution screen as the operation image. With the present invention, the enlarged operation image can be easily grasped visually even if display of a button or an icon to be operated is small or the configuration of the execution screen is complicated.

The operation history display screen according to the present invention can be displayed with a non-transparent or transparent background color. With the present invention, the viewability of the execution screen of the software or the operation history display screen can be enhanced by varying the background color of the operation history display screen. In addition, the viewability of the desktop screen of the OS etc., which is positioned under the execution screen of the software or the operation history display screen, can also be enhanced.

The operation history display screen according to the present invention can be configured not to receive a focus on the operation history display screen when the background color of the operation history display screen is transparent. With the present invention, the execution screen of the software, the desktop screen of the OS, etc., which is located under the operation history display screen, can be visually recognized if the background color of the operation history display screen is transparent. Alternatively, a focus can be set to the execution screen etc. from over the operation history display screen. Hence, the operability of the software etc. for the user is not impaired by the operation history display screen. The term “transparent” as used herein means both colorless transparent and colored transparent.

### Advantageous Effects of Invention

According to the present invention, a screen operation for software can be easily recorded as an operation image. According to the present invention, in addition, the operation content of the screen operation can be displayed using the operation image. Hence, the present invention can significantly contribute to improvements in work efficiency and productivity of various types of apparatuses and services that use software.

### BRIEF DESCRIPTION OF DRAWINGS

FIG. 1 illustrates the hardware configuration of an operation display apparatus according to an embodiment.

FIG. 2 illustrates the hardware configuration of a control section in FIG. 1.

FIG. 3 is a block diagram illustrating the functional configuration of the operation display apparatus according to the embodiment.

FIG. 4 is a data table according to the embodiment.

FIG. 5 illustrates an operation history display screen according to the embodiment.

FIG. 6 illustrates the operation history display screen which follows FIG. 5.

FIG. 7 illustrates the operation history display screen which follows FIG. 6.

FIG. 8 illustrates the operation history display screen which follows FIG. 7.

FIG. 9 illustrates the operation history display screen which follows FIG. 8.

FIG. 10 illustrates the operation history display screen which follows FIG. 9.

FIG. 11 is a flowchart illustrating operation of the operation display apparatus according to the embodiment.

FIG. 12 illustrates a modification of the operation display apparatus.

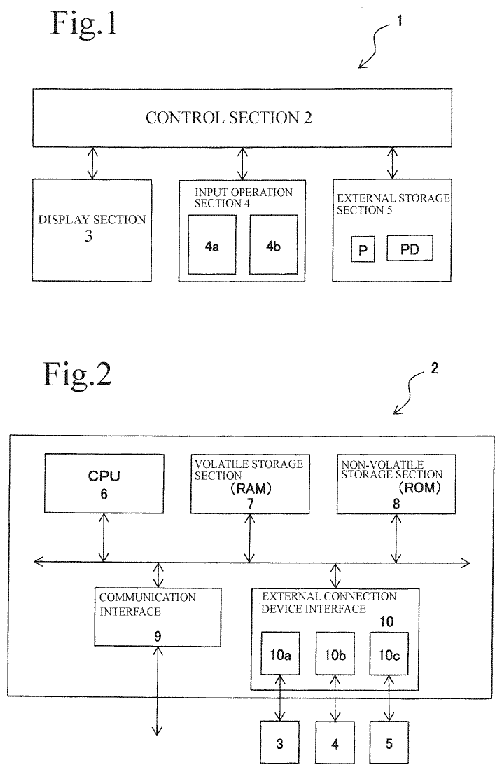

### DESCRIPTION OF EMBODIMENTS

An operation display apparatus and an operation display program according to an embodiment of the present invention will be described below with reference to the drawings.

An operation display apparatus 1 according to the present embodiment has a control section 2, a display section 3 which is a display screen such as a liquid crystal display apparatus connected to the control section 2 to display information output from the control section 2, an input operation section 4 that includes a keyboard 4a and a pointing device 4b and that is used to input information to the control section 2, and an external storage section 5 which is an external storage apparatus such as a hard disk apparatus. Such an operation display apparatus 1 can be constituted by a computer apparatus such as a notebook personal computer, a desktop personal computer, a tablet terminal, and a smartphone, for example.

The keyboard 4a of the input operation section 4 is constituted by hardware as a keyboard apparatus. The keyboard 4a also includes one constituted by software such as a virtual keyboard screen displayed on the screen of the smartphone or the tablet terminal, for example. Such a keyboard apparatus and a virtual keyboard screen each constitute an input apparatus of the computer apparatus, and may have any specific configuration, including key arrangement, that has the function of allowing key input.

Meanwhile, the pointing device 4b can be constituted by a mouse, a touch pad, a touch panel, a joystick, a pointing stick, a trackball, a pen tablet, etc. The configuration of the operation display apparatus 1 is not limited thereto.

FIG. 2 illustrates an example of the hardware configuration of the control section 2. As illustrated in the drawing, the control section 2 is mainly composed of semiconductor apparatuses and wiring that connects between such apparatuses, and has a CPU (Central Processing Unit) 6, a volatile storage section 7 which is a RAM (Random Access Memory), a non-volatile storage section 8 which is a ROM (Read Only Memory), a communication interface 9 connected to an access relay section, such as a fire wall or a switch, or a network, and an external connection device interface 10 for connection with external connection devices. The external connection device interface 10 has a display interface 10a for connection to the display section 3, an input interface 10b for connection to the input operation section 4, and a memory interface 10c for connection to the external storage section 5. The configuration of the control section 2 is not limited thereto.

In the operation display apparatus 1, the CPU 6 of the control section 2 executes software, that is, the OS and the various types of applications executed on the OS, to implement the function of the software. Examples of the applications include word processing software, spreadsheet software, programming software, and CAD software. However, visualization of input operations for an application by the operation display apparatus 1 can be applied to not only such examples of applications, but also the OS and any application executed on the OS. An operation display program P operates in the background of such applications.

The operation display apparatus 1 and the operation display program P record and visualize not only key operations performed using the keyboard 4a, but also screen operations performed using the pointing device 4b which could not be recorded or visualized in the related art. Consequently, it is possible to visually communicate how to operate an application efficiently and effectively.

The CPU 6 of the control section 2 controls operation of the entire computer apparatus, which functions as the operation display apparatus 1, by temporarily storing the operation display program P, which is stored in the external storage section 5, in the volatile storage section 7 and executing the operation display program P. By executing the operation display program P, the computer apparatus is caused to function as various functional sections to be discussed later (an operation history display control section 11, a key operation history control section 12, a screen operation history control section 13, an operation history display section 23, and an operation history storage section 24).

The external storage section 5 is constituted by a storage apparatus such as a HDD, and stores the operation display program P. The external storage section 5 also stores a data table PD to be discussed later. Further, the external storage section 5 functions as the operation history storage section 24, and accumulates operation history data that include key input data, operation images, and movies acquired by the operation display apparatus 1.

### Configuration of Operation History Display Control Section 11:

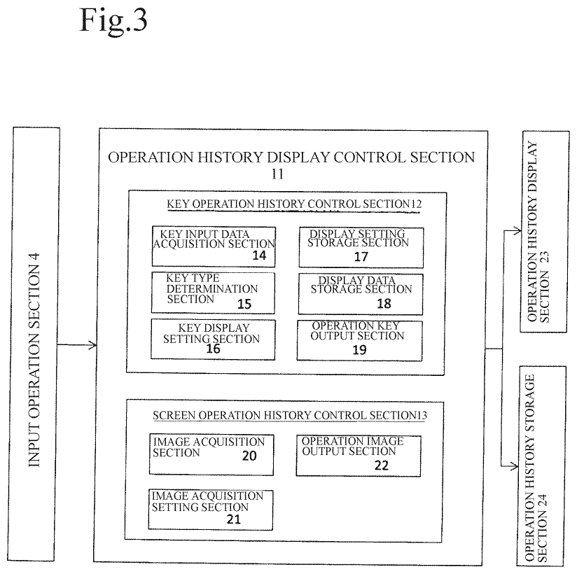

FIG. 3 is a block diagram illustrating the functional configuration of the operation display apparatus 1 which is implemented by the control section 2 executing the operation display program P. The control section 2 functions as the operation history display control section 11 by executing the operation display program P.

The operation history display control section 11 controls recording of data stored in the volatile storage section 7 and the non-volatile storage section 8 and various types of data generated by the CPU 5 in the external storage section 5, and display of such data on the display section 3. Therefore, the operation history display control section 11 includes the key operation history control section 12 which controls recording and display of key operations performed using the keyboard 4a, and the screen operation history control section 13 which controls recording and display of screen operations performed using the pointing device 4b.

The control section 2 executes a key input data acquisition section 14, a key type determination section 15, a key display setting section 16, and an operation key output section 19, of the key operation history control section 12, as functional sections.

The control section 2 executes an image acquisition section 20, an image acquisition setting section 21, and an operation image output section 22, of the screen operation history control section 13, as functional sections.

In addition, the control section 2 causes the external storage section 5 to function as a display setting storage section 17 and a display data storage section 18 of the key operation history control section 12, and the operation history storage section 24 which accumulates the “operation history data” which include the key input data which are acquired by the key input data acquisition section 14 and the operation images which are acquired by the image acquisition section 20. The operation history storage section 24 receives the key input data and the operation images, which serve as the operation history data, from the key operation history control section 12 and the screen operation history control section 13, and accumulates such data. The operation history data to be accumulated include, in addition to the key input data and the operation images, at least time information associated with each of the key input data and the operation images (year, month, day, hour, minute, and second of the time of acquisition of the key input data and the operation images) and identification information of the software (such as the name of the software which is used to acquire the key input data and the operation images). Besides, the operation history data may include user information on the user who uses the operation display apparatus 1.

More specifically, the operation history data are saved in the operation history storage section 24 as an “operation history file” generated by the operation display program P. The operation history file can be prepared in a file format such as the rich text format or the HTML format, for example. Therefore, the operation history file can be displayed on an operation history display screen W3 by the operation history display section 23 of the operation display program P. Instead of using the operation display program P, the operation history file can be displayed by word processing software and a browser. Thus, the operation history data can also be displayed by a computer apparatus in which the operation display program P is not installed, and an operation history of one operation display apparatus 1 can be shared by a plurality of computer apparatuses.

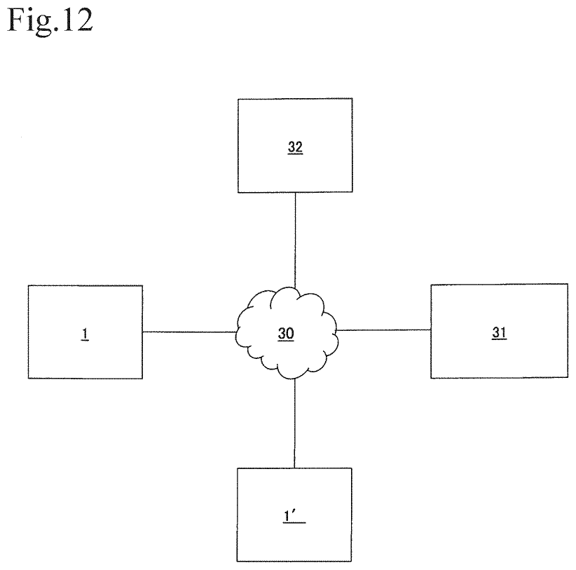

The operation history file can be saved at a desired timing by the user of the operation display apparatus 1 giving a name thereto. For example, the operation history file can be saved each time the operation display program P is ended. It is not necessary that the operation history file should always be prepared by the operation display apparatus 1. For example, the operation display apparatus 1 may transmit operation history data to a different terminal apparatus 31 connected via a communication network 30, and the terminal apparatus 31 may prepare an operation history file and save the operation history file in a storage apparatus thereof (see FIG. 12).

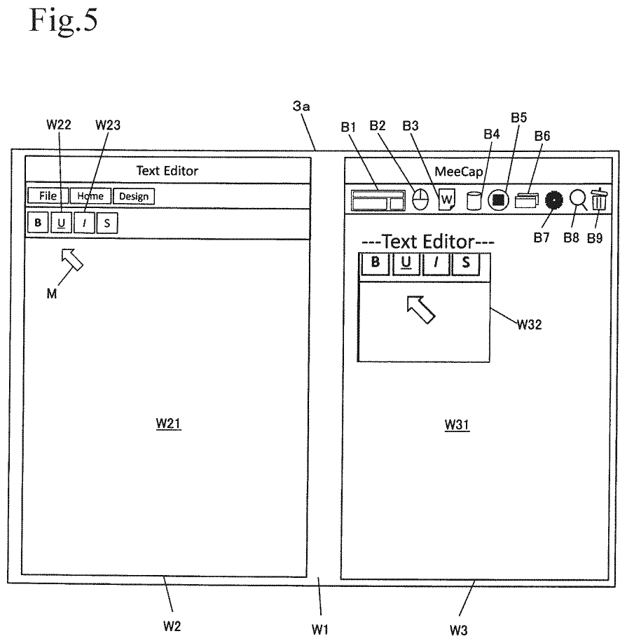

Further, the control section 2 causes the display section 3 to function as the operation history display section 23 which displays the operation history display screen W3 (see FIG. 5).

### Configuration of Key Operation History Control Section 12:

The key input data acquisition section 14 acquires key input data generated by key operations performed for the OS and the various types of applications executed on the OS. The term “key input” as used herein means input performed by operating the input operation section 4. Thus, the “key input” is not limited to being performed using a key arrangement such as that of a keyboard or a virtual keyboard displayed on a touch panel. Each time key input data generated for each key operation are acquired, the key input data acquisition section 14 receives time information from the system clock of the OS through the CPU 6, and acquires individual key operations and the time information, at which the key operations are performed, in association with each other. The key input data acquisition section 14 can also acquire the name of the application, for which key operations are performed, in association with the key operations. This allows one to grasp and manage the year, month, day, and time (hour, minute, and second) when each key operation is performed and the application for which the key operation is performed. The name of the application may be acquired when a focus is set to the application.

The key type determination section 15 determines the type of the key for which the key input data are generated. For example, in the case where a keyboard is used, the keyboard includes keys (display keys) that can be displayed, as they are, on the operation history display screen W3, and keys (non-display keys) that cannot be displayed. The key type determination section 15 determines which of such keys the key input data acquired by the key input data acquisition section 14 correspond to.

For the former, if an input operation is performed on a key with the alphabet “A” on top thereof on the word processing software, for example, the alphabet “A” is displayed on the execution screen of the word processing software, and thus one can see the operated key from the execution screen of the application, even if he/she is not the operator. In the case where the input operation performed on the application and the screen display of the input result coincide with each other, the letter “A” is displayed on the operation history display screen W3. Such keys are the “display keys”.

In contrast, nothing is displayed on the execution screen of the word processing software even if a “modification key” (such as the shift key and the control key) is pressed on the word processing software, for example. For such “non-display keys”, people other than the operator cannot see which key has been operated from the execution screen, and do not even notice that any key has been operated. That is, the input operation and the screen display of the input result do not coincide with each other. However, experienced persons often perform input operations by making frequent use of the modification keys to perform input work efficiently and effectively, and there is much to be learned from such input operations. Thus, in the present embodiment, the “non-display keys” such as the modification keys are displayed on the operation history display screen W3 together with other keys used in combination with the “non-display keys”. For example, in the case where a key for the alphabet “C” is operated after the control key “CTRL”, “CTRL+C” is displayed on the operation history display screen W3.

For the “lock keys” such as the capital lock key (CAPS) and various types of “functional keys” such as escape key, hankaku/zenkaku key, conversion key, non-conversion key, function keys, katakana/hiragana key, and arrow keys, as with the modification keys, the input operation and the screen display of the input result do not coincide with each other, and therefore the functional keys are displayed on the operation history display screen W3. For example, in the case where a right arrow key for moving a cursor is operated, a symbol “→” is displayed on the operation history display screen W3. The cursor is displayed on the execution screen of the application, and is moved on the execution screen when the arrow keys are operated. Since such movement is not easily noticeable, however, the arrow keys are also treated as the “non-display keys” in the present embodiment.

The key display setting section 16 correlates the operated keys and key display displayed on the operation history display screen W3. The correlation is managed for each application executed on the OS. The correlation includes the following three patterns, for example.

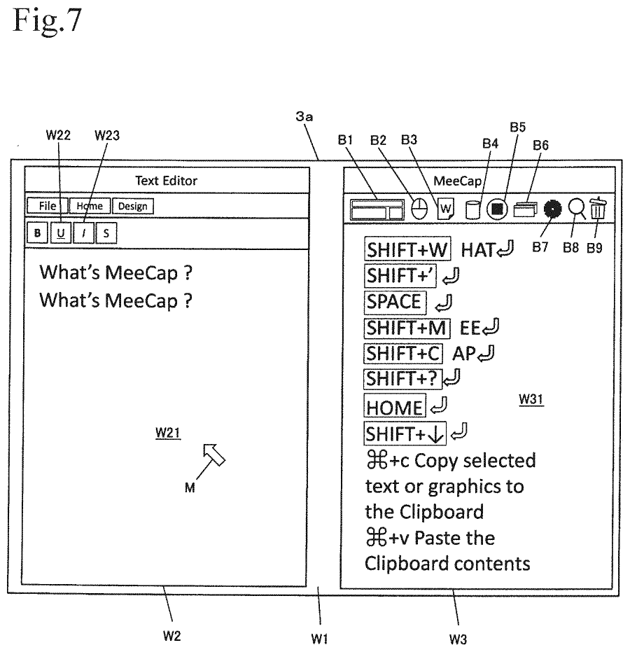

In the first pattern, when a non-display key such as a modification key or a functional key is operated, the following key operation is waited for, and the non-display key and the following key are set as “single key display”. For example, when “CTRL” is operated to be held down and “C” is operated thereafter, “CTRL+C” is set as “single key display”. In the case where a modification key or a functional key is operated in combination with the following key in this manner, the key display setting section 16 can set such keys as “single key display” with a description of the function added. For example, the key display setting section 16 can set such keys as displayed as “CTRL+C Copy” (see FIG. 7).

In the second pattern, a specific character string defined by the application is treated as “single key display”. For example, in the case of programming software, functions used in the C language have been defined, and a character string for the function “fprintf” would be difficult to see if the character string is displayed with one character in each line. In such a case, the character string for the function “fprintf” is set as “single key display”. Such setting is made for each application in accordance with the feature of the application.

In the third pattern, one key operation is set as “single key display”. For example, in the case where key input for the alphabet “A” is performed, key display for “A” is performed as it is. For the “ENTER” key, meanwhile, a character string, logo, or symbol for “ENTER” is set as “single key display”.

The key display setting section 16 also sets key display to be displayed for each line on the operation history display screen W3. For example, firstly, the key display setting section 16 can perform setting such that only “single key display” is displayed in one line. Secondly, the key display setting section 16 can set the upper limit number of “single key displays” to be displayed in one line. Thirdly, the key display setting section 16 can set the number of “single key displays” to be displayed in one line in accordance with the width of the display screen of the operation history display screen W3. Fourthly, the key display setting section 16 can set the upper limit of the stop time of key input operations, and display key display in the next line in the case where the upper limit is exceeded. Fifthly, the key display setting section 16 can perform setting for display by combining the second to fourth settings discussed earlier as desired. If there are so large a number of key displays to be displayed in one line, it is difficult to grasp fast and complicated key operations. Therefore, two to four key displays are preferably displayed, even in the case where a plurality of key displays are displayed. Such setting for key displays to be displayed in one line is made for each application in accordance with the feature or the necessity of the application.

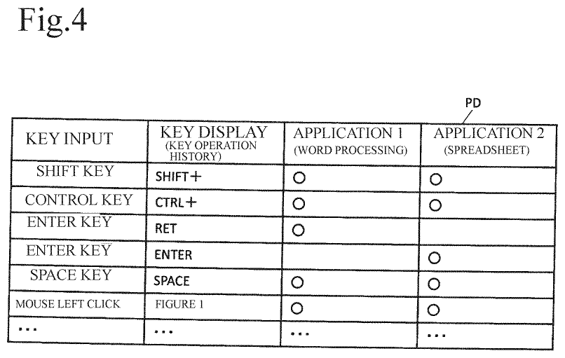

The display setting storage section 17 stores setting for key display to be displayed for a predetermined key operation set by the key display setting section 16. The display setting storage section 17 stores the data table PD illustrated in FIG. 4, for example. In the data table PD, “key display (key operation history)” for key input and applications to which the key input is applied are correlated with each other. Different key displays can be applied to the same key input among the applications. The data table PD illustrated in FIG. 4 may be prepared individually for each application.

The display data storage section 18 stores image data to be used as key display to be displayed for each key input by the key display setting section 16. The image data may be a standard character, a stylized or decorated logo, a figure, or a symbol.

The operation key output section 19 references the data table PD for display setting to be discussed later for the application to which the operation display program P is applied, and performs control so as to sequentially output key displays corresponding to the operation keys to the operation history display section 23. It is not necessary to set key display for all the operation keys. Thus, key input data acquired by the key input data acquisition section 14, except for the non-display keys, can be output, as they are, to the operation history display section 23, or stored in the operation history storage section 24.

### Configuration of Screen Operation History Control Section 13:

The screen operation history control section 13 has an image acquisition section 20, an image acquisition setting section 21, and an operation image output section 22.

The image acquisition section 20 generates and acquires an operation image by partially clipping (capturing) an operation point and the surrounding region of the operation point from the execution screen of the application for each screen operation performed using the pointing device on the OS and the various types of applications executed on the OS. The operation image is clipped such that the operation point of an operation performed on a display screen 3a of the display section 3 (the operation position on the display screen 3a at which a pointer operation or a touch operation is performed) is determined as the center coordinate and the operation image includes the surrounding region of the operation point with predetermined shape and size. The shape and the size are set by the image acquisition setting section 21. The clipped operation image can be generated as image data of a format such as JPEG, GIF, and PNG. The format of the image file can be designated by the image acquisition setting section 21 to be discussed later.

Each time an operation image generated for each screen operation is acquired, the image acquisition section 20 receives time information from the system clock of the OS through the CPU 5, and acquires individual operation images and the time information in association with each other. This allows one to grasp and manage the year, month, day, and time when each screen operation is performed. Examples of the screen operation for which an operation image is generated include not only a left click performed on a button on the execution screen using the mouse, but also a left click performed at a location on the execution screen at which no button or other commands are present. That is, the image acquisition section 20 generates an operation image upon detecting that the user executes a click operation or a touch operation using the input operation section 4 on the execution screen. An operation image is not necessarily generated when any command is executed by performing a click operation or a touch operation.

The image acquisition setting section 21 makes various settings when the image acquisition section 20 generates an operation image by partially clipping the execution screen of the application. For example, the image acquisition setting section 21 sets the shape and the size of an operation image to be clipped from the execution screen, or sets the display magnification at which the clipped execution screen is to be enlarged. In addition, the image acquisition setting section 21 can set the image file format of an operation image to be generated.

The operation image output section 22 performs control so as to sequentially output the operation images acquired by the image acquisition section 20 to the operation history display section 23 and the operation history storage section 24.

The operation history display section 23 performs a process of displaying the operation history display screen W3 on the display screen 3a of the display section 3.

The operation history storage section 24 performs a process of temporarily storing the operation history data (operation history file) in the volatile storage section 7, or saving such data in the external storage section 5 which is non-volatile.

### Description of Display Screen of Operation Display Apparatus 1:

FIGS. 5 to 10 illustrate examples of the display screen 3a of the display section 3. A desktop screen W1 of the OS is displayed on the entire display screen 3a. An execution screen W2 of an application “Text Editor” for editing text is displayed on the left side of the desktop screen W1. An operation history display screen W3 is displayed on the right side of the execution screen W2. “MeeCap” at the upper portion of the operation history display screen W3 is the name of the operation display program P according to the present embodiment. In the embodiment described below, a mouse is used as the pointing device 4b, and a pointer operation is performed as a “screen operation”.

First, a focus is set to the application “Text Editor”. After a pointer M is moved to a text input field W21 of the execution screen W2 by operating the mouse, a click is performed on the left button of the mouse. Then, the screen operation history control section 13 displays the name of the application “- - - Text Editor - - - ”, to which a focus has been set, in a drawing region W31 of the operation history display screen W3. In addition, the image acquisition section 20 of the screen operation history control section 13 generates an operation image W32 by clipping a part of the execution screen W2 by screen-capturing the execution screen W2 in a range set by the image acquisition control section 21 around the center coordinate of the pointer M. The operation image W32 is output by the operation image output section 22 to the drawing region W31 of the operation history display screen W3, and displayed under the application name discussed earlier as illustrated in FIG. 5. Time information may be displayed side by side with the operation image W32.

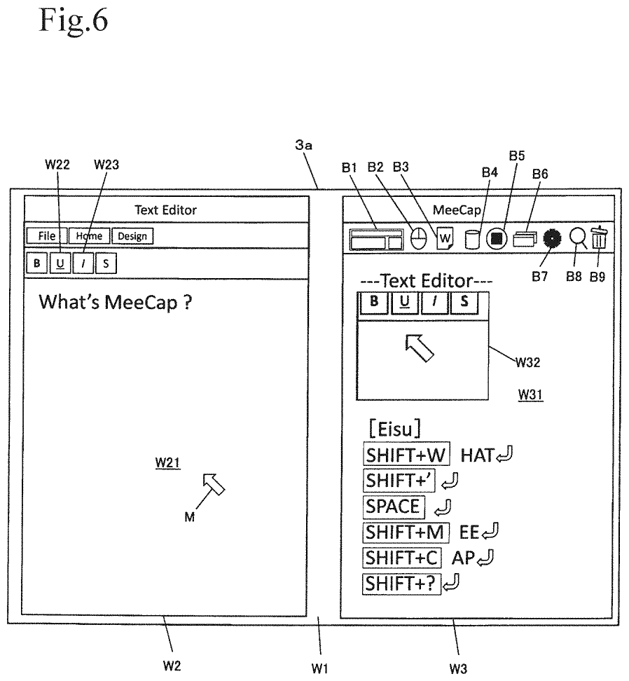

Next, when the “Eisu” key which is a non-display key is pressed using the keyboard 4a, the key operation history control section 12 displays a character string [Eisu] as the operation key in the drawing region W31 of the operation history display screen W3 as illustrated in FIG. 6. Subsequently, “What's MeeCap?” is input using the keyboard 4a. Then, all the character string input to the text input region W21 through key operations is displayed as the operation keys in the drawing region W31 of the operation history display screen W3 in FIG. 6.

Operations to select, copy, and paste the character string “What's MeeCap?” input to the text input region W21 in FIG. 6 will be described with reference to FIG. 7. First, the “HOME” key is pressed to move the cursor in the text input region W21 to the head of the line. Consequently, key display of the “HOME” key is displayed as the operation key in the drawing region W31 of the operation history display screen W3 as illustrated in FIG. 7.

The character string “What's MeeCap?” is selected by pressing the “↓” arrow key while pressing the “SHIFT” key. Consequently, key display of “SHIFT+↓” is displayed as the operation key in the drawing region W31 of the operation history display screen W3.

Further subsequently, the character string is copied to the clipboard by pressing “C” together with the “CTRL” key. Consequently, key display of “command symbol+c” is displayed as the operation key in the drawing region W31 of the operation history display screen W3. Together with the key display, a description “Copy selected text or graphics to the Clipboard” that indicates the meaning of the key display is displayed as key display. The content of such a description of the function can be set using the key display setting section 16.

Next, the character string which has been copied to the clipboard is pasted to the text input region W21 as illustrated in FIG. 7 by pressing “V” together with the “CTRL” key. Consequently, key display of “command symbol+v” is displayed as the operation key in the operation history display screen W3, and a description “Paste the Clipboard contents” is displayed together as key display. The content of such a description can also be set using the key display setting section 16.

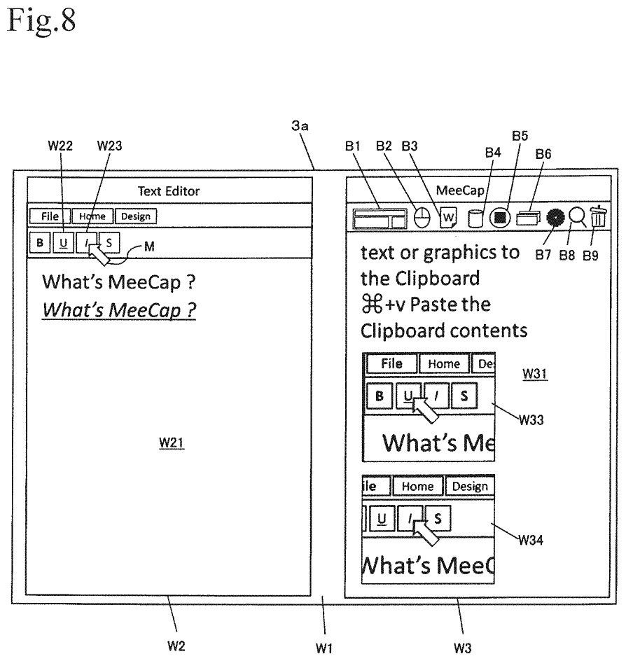

In FIG. 8, pointer operations to underline and further italicize the character string “What's Meecap?” in the second line of the text input region W21 are performed. First, from the state in which the character string in the second line is selected, the mouse is operated to click with the pointer M on an underline button W22 on the execution screen W2. Consequently, an operation image W33 is displayed in the drawing region W31 of the operation history display screen W3, as with the operation image W32. Subsequently, the mouse is operated to click with the pointer M moved to an italic button W23 on the execution screen W2. Consequently, an operation image W34 is displayed in the drawing region W31 of the operation history display screen W3. The pointer operations on the operation buttons W22 and W23 on the execution screen W2 of the application can be visualized in this manner.

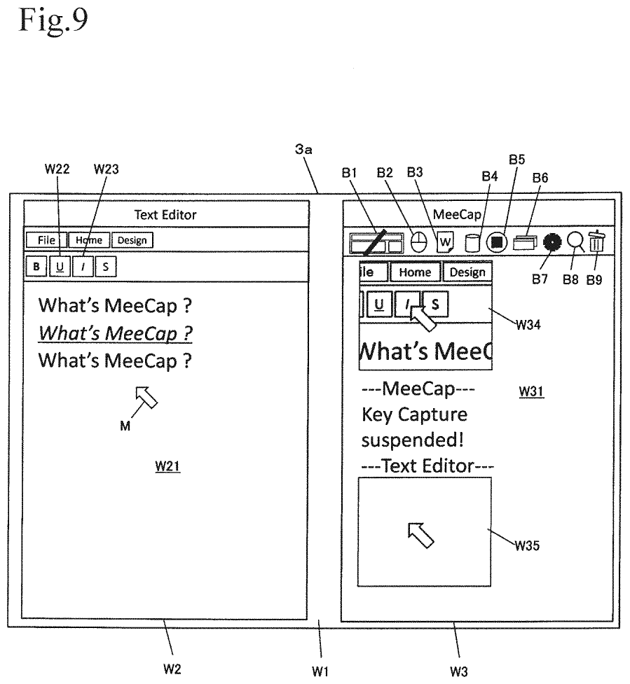

FIG. 9 illustrates the function of the operation display program P. Various types of operation buttons B1 to B9 are disposed at the upper portion of the operation history display screen W3 of the operation display program P.

The operation button B1 in the shape of a keyboard is a button for displaying and hiding operation keys on and from the drawing region W31 of the operation history display screen W3. When the operation button B1 is clicked by a pointer operation to be ticked as illustrated in FIG. 9, a character string “- - - MeeCap - - - ”, which indicates that a focus has been set to “MeeCap”, is displayed in the drawing region W31 of the operation history display screen W3. A character string “Key Capture suspended!” is displayed under the character string “- - - MeeCap - - - ”, and thereafter operation keys are not displayed in the drawing region W31 of the operation history display screen W3. In FIG. 9, an operation image W35 at the time when a focus is set from the operation history display screen W3 to the execution screen W2 is displayed in the drawing region W31, but operation keys corresponding to a character string “What's MeeCap?” input in the third line of the text input region W21 thereafter are not displayed under the operation image W35. This allows confidential information, such as a password input to the application, to be not displayed on the operation history display screen W3.

The operation button B2 in the shape of a mouse is a button for displaying and hiding operation images on and from the drawing region W31 of the operation history display screen W3. When the operation button B2 is clicked by a pointer operation to be ticked, operation images are not displayed in the drawing region W31 of the operation history display screen W3. This allows highly confidential pointer operations etc. to be not displayed.

The operation button B3 in the shape of a letter “W” on a paper figure is a button for enabling and disabling operations to edit the drawing region W31 of the operation history display screen W3. When the operation button B3 is clicked by a pointer operation, text in the drawing region W31 of the operation history display screen W3 can be edited. This allows editing work such as adding a description to the operation images W32 to W34, for example, to be performed.

The operation button B4 in the shape of a circular column is a button for saving a content displayed in the drawing region W31 of the operation history display screen W3 in the external storage section 5 as the operation history data.

The operation button B5 in the shape of a square disposed in a circle is a record button for recording the entire desktop screen W1 as a movie. The operation display apparatus 1 illustrated in FIG. 3 has a “movie acquisition section” separately from the operation history display control section 11. This allows variations in the entire desktop screen W1, which includes the execution screen W2 of the application and the operation history display screen W3, to be recorded as a movie.

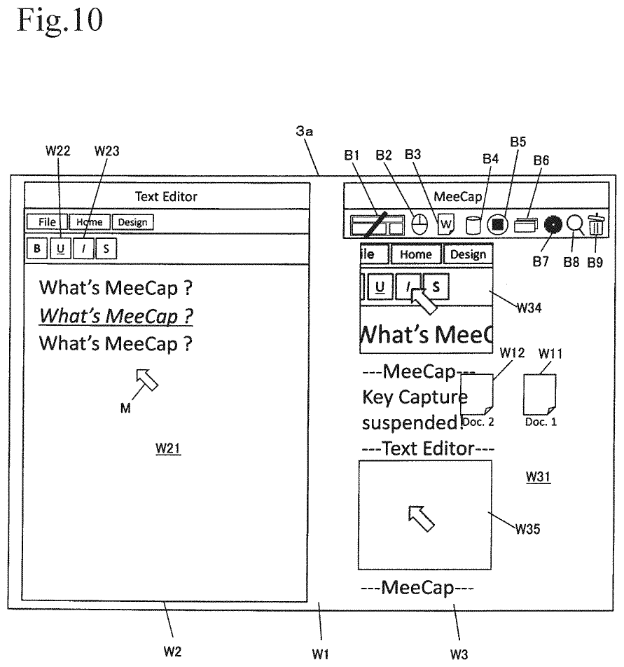

The operation button B6 in the shape of screens disposed as superposed on each other is a button for switching the background color of the drawing region W31 of the operation history display screen W3 between non-transparent and transparent. When the operation button B6 is clicked by a pointer operation, the background color of the drawing region W31 of the operation history display screen W3 is varied from white to colorless transparent as illustrated in FIG. 10, for example. In the transparent state, the operation history display control section 11 is set so as not to receive a focus on the operation history display screen W3. That is, as illustrated in FIG. 10, pointer operations on icons W11 and W12 located on the desktop screen W1, which is superposed on the operation history display screen W3, can be performed. Thus, the operability of the applications and the OS is not impaired by the operation history display screen W3.

The operation button B7 is a button for displaying various types of setting screens. Specifically, the following setting can be made, for example.

[Font setting] The font setting such as the style, such as the font size and the font color, of operation keys displayed in the drawing region W31 and the background color of the drawing region W31 is displayed.
[Key capture setting 1] Only key display of the non-display keys such as the modification keys and the functional keys is displayed as the operation key in the drawing region W31.
[Key capture setting 2] The meaning of the modification keys, the functional keys, etc. is also displayed when such keys are pressed (see FIG. 7).
[Key capture setting 3] In the case where the operation button B1 is turned off (FIG. 9), the operation button B1 is automatically turned on again when five seconds, for example, elapse since the last key operation.
[Mouse capture setting] The size of the operation image to be clipped is adjusted.

The operation button B8 is a search button for searching the drawing region W31. When the operation button B8 is clicked by a pointer operation, a search screen is displayed (not illustrated). When a search word is input to the search screen to execute a search, an operation history including the search word is displayed. The name of the software, a desired character string, an operation image, and time information can be used as the search condition.

In the case where a search is made for a past operation history file saved in the external storage section 5, the search can be made on the search screen by opening the file using the operation display program P. In the case where a past operation history file is saved in the rich text format, in addition, the search can be made by opening the file using general-purpose word processing software or a browser and using a search function implemented in such software.

The operation button B9 is a button for deleting all the content displayed in the drawing region W31 of the operation history display screen W3.

In the description of FIGS. 5 to 10, only the execution screen W2 of the application “Text Editor” is displayed on the desktop screen W1 of the OS. However, execution screens of one or more different applications may be displayed side by side therewith. Alternatively, the execution screen may be minimized, rather than being displayed on the desktop screen W1.

In the case where a plurality of applications are used alternately, key display and operation images for an application A currently operated are displayed in the drawing region W31 of the operation history display screen W3, and, when a focus is switched to a different application B, the name of the application B is displayed subsequently to the operation history for the application A, and key display and operation images for the application B are displayed. That is, operation histories for a plurality of applications are displayed successively in the drawing region W31. This allows one to know what applications the user uses in combination (the association between applications used in business). In the case where there are many operation histories to be displayed in the drawing region W31, such operation histories can be seen by scrolling the display.

### Description of Operation Flow of Operation Display Apparatus 1:

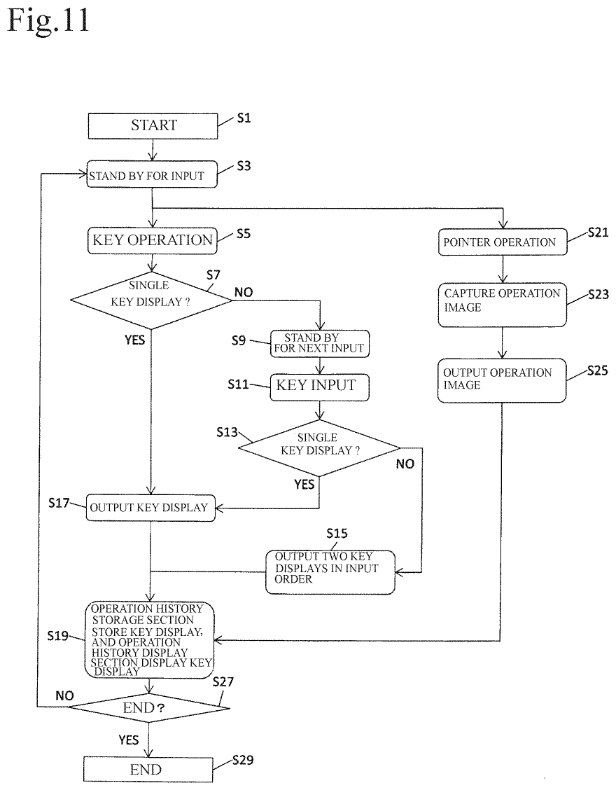

FIG. 11 is an operation flowchart of the operation display apparatus 1 which executes the operation display program P.

When the operation display program P is started (S1), the operation display apparatus 1 stands by for a key operation or a pointer operation (screen operation) to be performed for an application to which a focus has been set (S3). That is, the key input data acquisition section 14 stands by to acquire key input data generated by key input performed using the input operation section 4. In addition, the image acquisition section 20 stands by for a pointer operation to be performed using the input operation section 4.

When the key input data acquisition section 14 acquires key input data (S5), the key type determination section 15 determines whether or not the key input data correspond to key input corresponding to “single key display” (S7). For example, in the case where key input data due to key input of “CTRL” is acquired, the key type determination section 15 does not determine the key input alone as “single key display”, and the operation display apparatus 1 stands by for the next input (S9).

In the case where key input data due to key input of the alphabet “A”, for example, is acquired, on the other hand, the key type determination section 15 determines the key input alone as “single key display” (S7). Then, the operation key output section 19 executes a process of outputting key display “A” corresponding to the key input to the operation history display section 23 and the operation history storage section 24 (S17). Consequently, the operation history display section 23 displays the key display “A” as the operation key on the operation history display screen W3. In addition, the operation history storage section 24 temporarily stores the key display in the volatile storage section 7, or stores the key display in the external storage section 5 (S19).

Returning through the steps, when the operation display apparatus 1 stands by for the next input in step S9 and the next key input is made, the key input data acquisition section 14 acquires key input data (S11), and the key type determination section 15 determines whether or not the key input data correspond to key input that constitutes “single key display” when combined with the preceding key input data (S13) in the same manner as described above. Here, the key input follows “CTRL”, and therefore the key type determination section 15 determines whether or not the input key is complete as an input operation when combined with “CTRL”. If key input for “C” or “V” is made, for example, “CTRL+C” or “CTRL+V” is determined as “single key display”. The operation key output section 19 executes a process of reading the corresponding key display “CTRL+C” or “CTRL+V” from the display data storage section 18 and outputting the key display to the operation history display section 23 and the operation history storage section 24 (S17). Consequently, the operation history display section 23 displays the corresponding key display as “single key display” and the operation key in the drawing region W31. In addition, the operation history storage section 24 temporarily stores the key display in the volatile storage section 7, or stores the key display in the external storage section 5 (S19).

On the other hand, in the case where it is determined in step S13 that the next key input is not complete as an input operation when combined with the preceding “CTRL”, the operation key output section 19 outputs key display corresponding to such key inputs to the operation history display section 23 and the operation history storage section 24 in the input order (S15). Consequently, the operation history display section 23 displays the corresponding key display as “single key display” in the drawing region W31. In addition, the operation history storage section 24 temporarily stores the key display in the volatile storage section 7, or stores the key display in the external storage section 5 (S19).

Returning through the steps, in the case where a pointer operation is performed (S21) in the state of standing by for input in step S3, the image acquisition section 20 acquires an operation image acquired by capturing the execution screen 21 (S23), and the operation image output section 22 outputs the operation image to the operation history display section 23 and the operation history storage section 24 (S25). The operation history display section 23 displays the operation image in the drawing region W31. In addition, the operation history storage section 24 temporarily stores the operation image in the volatile storage section 7, or stores the operation image in the external storage section 5 (S19).

The series of steps described above is executed for each key operation and each pointer operation. In the case where execution of the operation display program P is ended (S27), the operation display program P is also ended (S29).

With the operation display apparatus 1 and the operation display program P described above, all the key operations and the pointer operations performed for an application can be displayed on the operation history display screen W3. Hence, operations for an application can be easily grasped visually. In addition, a history of all the key operations and the pointer operations performed for an application can be stored in the operation history storage section 24. Hence, the operation image can be checked repeatedly even after the operation image is saved.

While an embodiment of the present invention has been described above, the present invention is not limited to the embodiment described above, and a variety of modifications, substitutions, additions, etc. may be made without departing from the scope and spirit of the present invention.

For example, the operation display program P according to the embodiment described above can be provided as a storage medium that is readable by a computer apparatus. The storage medium may be a storage medium of any storage format that can store a program and that is readable by a computer apparatus, such as a magnetic disk, an optical disk (such as CD-ROM, CD-R, and DVD), a magneto-optical disk (such as MO), and a semiconductor memory.

In addition, the operation display program P according to the embodiment described above may be stored in a computer apparatus connected to a network such as the Internet, and provided by being downloaded by way of the network.

A series of operation data including the operation keys and the operation images W32 to W35 displayed in the drawing region W31 of the operation history display screen W3 and movie data acquired by operating the operation button B5 can be stored in the external storage section 5 of the computer apparatus which constitutes the operation display apparatus 1. Alternatively, as illustrated in FIG. 12, such data can be stored in a storage apparatus of a terminal apparatus 31 connected to the operation display apparatus 1 via a communication network 30. This allows the content of operations performed on the operation display apparatus 1 to be shared with a different operation display apparatus 1′, or to be managed by a management terminal 32.

It is not essential for the operation display apparatus 1 to display the operation history display screen W3. For example, the operation display program P may be executed in the background of the OS and the applications of the operation display apparatus 1, and operation history data (such as key input data and operation images) generated by the operation display apparatus 1 may be automatically transmitted to the terminal apparatus 31, which is connected via the communication network 30, to be stored in a storage apparatus of the terminal apparatus 31. In this manner, there can be provided an “operation information collection system” that includes a plurality of operation terminals (operation display apparatuses 1) and an operation information collection server (terminal apparatus 31) connected to the operation terminals via the communication network 30, the operation terminals transmitting generated operation history data to the operation information collection server through the communication network, and the operation information collection server storing the operation history data, which are received from the operation terminals, in the storage apparatus. The operation information collection server can generate an operation history file from the received operation history data. With such an operation information collection system, the operation histories of the operation terminals can be recorded by the operation information collection server. The operation information collection server can also display the operation histories. The operation histories can be visualized by distributing the operation history data (operation history file) saved in the operation information collection server to one or more operation terminals. The operation terminals may transmit the operation history data in real time or at a desired timing. Viewing of the operation history data (operation history file) stored in the operation information collection server by the operation terminals may be restricted, and such data may be viewable by the management terminal 32 only or by the management terminal 32 and an operation terminal, access restriction for which has been disabled, only.

The terminal apparatus 31 which stores operation history data of the operation display apparatus 1 can be constituted as a server (operation history analysis server 31) that provides an analysis function of analyzing the operation history data. Several examples of the analysis function will be described.

### (1) Investigation of Actual Operation Processing Amount

The operation history analysis server 31 can analyze the “application-specific use time”. The operation history analysis server 31 can summarize applications used by each individual, group, and organization. Consequently, it is possible to analyze whether the work force concentrates on a system that makes a profit, how much time is spent on a management system that conversely does not make a profit, what a preferable rate of use of an application is when combined with a KPI such as the sales amount, etc.

The operation history analysis server 31 can analyze “how to use the time”. The operation history analysis server 31 visualizes the order of use of applications that are used. Consequently, it is possible to analyze if the work being performed near the finishing time is not carried over to the next day etc.

### (2) Analysis and Discussion of Operation Execution Method

The operation history analysis server 31 can analyze the “individual-specific business processing method”. The operation history analysis server 31 visualizes variations in operation image (such as the number of screen transitions) during use of a business application. Consequently, it is possible to analyze if there is not a difference in work efficiency between a person with high work skills and a person with low work skills. Meanwhile, if the folder system is complicated, it takes wasteful time to find a work file to use. It is possible to analyze the efficiency of a folder management method on the basis of variations in operation image (number of screen transitions) made until a work file to use is reached.

### (3) Analysis and Discussion of Approach for Improving Productivity

The operation history analysis server 31 can analyze the “estimation of the effect of RPA introduction and standard work systematization”. The operation history analysis server 31 visualizes the performance of use (such as frequency and time of use) of a plurality of applications used for various work, for example. Therefore, the improvement and effect of RPA (Robotic Process Automation) introduction and systematization can be analyzed quantitatively for work with applications that are used frequently or for a long time.

The operation display apparatus 1, the operation display program P, and the operation display method according to the present invention can be applied to any apparatus that allows screen operations using software, such as smartphones, gaming devices, industrial devices, medical devices, besides personal computers and tablet terminals mentioned at the beginning of the description of the present embodiment.

### REFERENCE SIGNS LIST

1 OPERATION DISPLAY APPARATUS

2 CONTROL SECTION

3 DISPLAY SECTION

3a DISPLAY SCREEN

4 INPUT OPERATION SECTION

4a KEYBOARD

4b POINTING DEVICE

5 EXTERNAL STORAGE SECTION

6 CPU

7 VOLATILE STORAGE SECTION

8 NON-VOLATILE STORAGE SECTION

9 COMMUNICATION INTERFACE

10 EXTERNAL CONNECTION DEVICE INTERFACE

10a DISPLAY INTERFACE

10b INPUT INTERFACE

10c MEMORY INTERFACE

11 OPERATION HISTORY DISPLAY CONTROL SECTION

12 KEY OPERATION HISTORY CONTROL SECTION

13 SCREEN OPERATION HISTORY CONTROL SECTION

14 KEY INPUT DATA ACQUISITION SECTION

15 KEY TYPE DETERMINATION SECTION

16 KEY DISPLAY SETTING SECTION

17 DISPLAY SETTING STORAGE SECTION

18 DISPLAY DATA STORAGE SECTION

19 OPERATION KEY OUTPUT SECTION

20 IMAGE ACQUISITION SECTION

21 IMAGE ACQUISITION SETTING SECTION

22 OPERATION IMAGE OUTPUT SECTION

23 OPERATION HISTORY DISPLAY SECTION

24 OPERATION HISTORY STORAGE SECTION

30 COMMUNICATION NETWORK

31 TERMINAL APPARATUS

32 MANAGEMENT TERMINAL

M POINTER

W1 DESKTOP SCREEN

W11 to W12 ICON

W2 EXECUTION SCREEN OF APPLICATION

W21 TEXT INPUT REGION

W22 UNDERLINE BUTTON

W23 ITALIC BUTTON

W3 OPERATION HISTORY DISPLAY SCREEN

W31 DRAWING REGION

W32 to W35 OPERATION IMAGE

B1 to B9 OPERATION BUTTON

P OPERATION DISPLAY PROGRAM

PD DATA TABLE

1.-24. (canceled)

25. An operation information collection system comprising
a plurality of operation terminals, a management terminal, and a terminal apparatus, the plurality of operation terminals and the management terminal being connected to the terminal apparatus via a communication network,
wherein the operation terminals are each configured to be able to generate operation history data and transmit the operation history data to the terminal apparatus via the communication network,
the operation history data including a plurality of key input data and a plurality of operation images,
the key input data being data generated by making a key input for
at least one or more pieces of software executed by the operation terminals, and the operation images being data generated by partially capturing an operation point and a surrounding region of the operation point from an execution screen of the software when a screen operation is performed for the software, and
the terminal apparatus can generate an operation history file using the operation history data, and distribute the operation history file to at least one of the operation terminals and the management terminal via the communication network,
the operation history file being configured to enable display of the plurality of key input data and the plurality of operation images received from the operation terminals in a mixed manner in an order of input.

26. The operation information collection system according to claim 25, wherein the operation history data include time information on a time of acquisition of the key input data, time information on a time of acquisition of the operation images, and identification information on the software.

27. The operation information collection system according to claim 25, wherein the operation history data include user information on a user who uses the operation terminal.

28. The operation information collection system according to claim 25, wherein a file format of the operation history file is a rich text format or an HTML format.

29. The operation information collection system according to claim 25, further comprising a storage apparatus that stores the operation history data transmitted by the plurality of operation terminals.

30. The operation information collection system according to claim 29, further comprising a search section that searches the operation history data stored in the storage apparatus using a predetermined search condition.

31. The operation information collection system according to claim 25,
wherein the terminal apparatus is configured as an operation history analysis server that is able to analyze the operation history data,
the operation history analysis server being able to summarize a performance of use of each piece of the software on the basis of the operation history data.

32. The operation information collection system according to claim 25,
wherein the terminal apparatus is configured as an operation history analysis server that is able to analyze the operation history data,
the operation history analysis server being able to summarize a time of use of each piece of the software by each individual or each group on the basis of the operation history data,
the time of use of the operation terminal used by an individual being summarized for each individual, and the time of use of the plurality of operation terminals being summarized for each group.

33. The operation information collection system according to claim 25,
wherein the terminal apparatus is configured as an operation history analysis server that is able to analyze the operation history data,
the operation history analysis server being able to specify an order of use of the plurality of pieces of software on the basis of the operation history data.

34. The operation information collection system according to claim 25,
wherein the operation terminal is configured as an operation history analysis server that is able to analyze the operation history data,
the operation history analysis server being able to specify variations in the operation images on the basis of the operation history data.
